(19) United States
(12) Patent Application Publication
(10) Pub. No.: US 2026/0301427 A1
(43) Pub. Date: Oct. 1, 2026

(54) TRAFFIC SIGNAL RECOGNITION DEVICE, TRAFFIC SIGNAL RECOGNITION METHOD, VEHICLE CONTROL DEVICE, AND STORAGE MEDIUM

(71) Applicant: HONDA MOTOR CO., LTD., Tokyo (JP)

(72) Inventor: Chanjin Seo, Tokyo (JP)

(21) Appl. No.: 19/541,430

(22) Filed: Feb. 17, 2026

(30) Foreign Application Priority Data
Mar. 27, 2025 (JP) 2025-053374

(51) Int. Cl. G06V 20/58; B60W 50/14; G06V 10/56

(52) U.S. Cl. CPC G06V 20/584; B60W 50/14; G06V 10/56; B60W 2050/143; B60W 2050/146; B60W 2420/403; B60W 2555/60

(57) ABSTRACT

A traffic signal recognition device includes an imaging unit configured to capture a front-view image from a host vehicle, a traffic signal detecting unit configured to detect a traffic signal area including a target traffic signal from the front-view image captured by the imaging unit at intervals of a predetermined period, and a blinking determining unit configured to determine whether the target traffic signal included in the traffic signal area is blinking. The blinking determining unit determines whether the target traffic signal is blinking on the basis of a turn-off maintenance time which is a time in which turning-off of the target traffic signal is maintained and a turn-on maintenance time which is a time in which turning-on of the target traffic signal is maintained and outputs blinking information indicating a blinking state or a non-blinking state.

### CROSS-REFERENCE TO RELATED APPLICATION

Priority is claimed on Japanese Patent Application No. 2025-053374, filed Mar. 27, 2025, the content of which is incorporated herein by reference.

### BACKGROUND OF THE INVENTION

### Field of the Invention

The present invention relates to a traffic signal recognition device, a traffic signal recognition method, a vehicle control device, and a storage medium.

### Description of Related Art

In order to perform appropriate control when a traffic signal corresponding to a traveling lane blinks before a vehicle having a function such as an automated driving (AD) function or an advanced driver assistance systems (ADAS) function enters a crossing, it is necessary to recognize a blinking signal. For example, a vehicle-outside environment recognition device described in Patent Document 1 is known as such a type of technique.

The vehicle-outside environment recognition device described in Patent Document 1 identifies one or two or more traffic signals from an image obtained by imaging an outside environment, derives a three-dimensional position of the identified traffic signal, identifies which of a motorway in which only vehicles can travel and a regular road other than a motorway a traveling road on which a host vehicle is traveling is, and identifies a target traffic signal out of the identified one or two or more traffic signals on the basis of the three-dimensional position of the identified traffic signal and identification conditions referred to according to which of a motorway and a regular road the traveling road is.
[Patent Document 1] Japanese Patent No. 6240475

### SUMMARY OF THE INVENTION

However, the vehicle-outside environment recognition device described in Patent Document 1 identifies a target traffic signal and determines a signal color thereof, but, for example, it is not described that blinking of a traffic signal in a period of 0.4 seconds to 0.6 seconds is recognized. Accordingly, when a traffic signal changes from a blinking state to another state, it may not be possible to appropriately control traveling of the host vehicle.

Aspects of the present invention were invented in consideration of the aforementioned circumstances, and an objective thereof is to provide a traffic signal recognition device, a traffic signal recognition method, a vehicle control device, and a storage medium that can accurately recognize blinking of a traffic signal.

In order to achieve the aforementioned objective, the present invention employs the following aspects.

(1) According to an aspect of the present invention, there is provided a traffic signal recognition device including: an imaging unit configured to capture a front-view image from a host vehicle; a traffic signal detecting unit configured to detect a traffic signal area including a target traffic signal from the front-view image captured by the imaging unit at intervals of a predetermined period; and a blinking determining unit configured to determine whether the target traffic signal included in the traffic signal area is blinking, wherein the blinking determining unit determines whether the target traffic signal is blinking on the basis of a turn-off maintenance time which is a time in which turning-off of the target traffic signal is maintained and a turn-on maintenance time which is a time in which turning-on of the target traffic signal is maintained and outputs blinking information indicating a blinking state or a non-blinking state.

(2) In the aspect of (1), the traffic signal recognition device may further include a lamp color determining unit configured to determine a lamp color state indicating a turn-off color or a turn-on color of the target traffic signal included in the traffic signal area detected by the traffic signal detecting unit at intervals of the predetermined period, and the blinking determining unit may determine whether the target traffic signal is blinking on the basis of a pre-turn-off lamp color which is a lamp color immediately before the target traffic signal is turned off when the target traffic signal changes from a turn-on state to a turn-off state and a current turn-on color determined by the lamp color determining unit.

(3) In the aspect of (2), the blinking determining unit may perform: adding a predetermined amount of elapsed time to the turn-off maintenance time when a current lamp color state is a turn-off state; and changing the blinking information from a non-blinking state to a blinking state when the current lamp color state is not a turn-off state but indicates the same turn-on color as the pre-turn-off lamp color, and the turn-off maintenance time is greater than a first time threshold value corresponding to a predetermined blinking period.

(4) In the aspect of (3), the blinking determining unit may change the blinking information from the blinking state to the non-blinking state when the blinking information indicates the blinking state and the current turn-on color does not indicate the turn-off state but is not the same turn-on color as the pre-turn-off lamp color.

(5) In the aspect of (3), the blinking determining unit may change the blinking information from the blinking state to the non-blinking state when the blinking information indicates the blinking state and the turn-off maintenance time is less than a second time threshold value greater than the first time threshold value.

(6) In the aspect of (3), the blinking determining unit may perform: adding a predetermined amount of elapsed time to the turn-on maintenance time when the blinking information indicates the blinking state and the current turn-on color does not indicate the turn-off state but is the same turn-on color as the pre-turn-off lamp color; and changing the blinking information from the blinking state to the non-blinking state when the turn-on maintenance time is greater than a third time threshold value greater than the first time threshold value.

(7) In the aspect of (3), the blinking determining unit may perform: setting the turn-on maintenance time to an initial value when the current turn-on color indicates the turn-off state; and setting the turn-off maintenance time and the turn-on maintenance time to the initial value when the current turn-on color does not indicate the turn-off state but is a lamp color different from the pre-turn-off lamp color.

(8) In the aspect of (3), the blinking determining unit may perform: outputting the pre-turn-off lamp color as the turn-on color of the target traffic signal when the blinking information indicates the blinking state; and outputting the current turn-on color as the turn-on color of the target traffic signal when the blinking information indicates the non-blinking state.

(9) According to another aspect of the present invention, there is provided a vehicle control device including: a traffic signal recognition device including an imaging unit configured to capture a front-view image from a host vehicle, a traffic signal detecting unit configured to detect a traffic signal area including a target traffic signal from the front-view image captured by the imaging unit at intervals of a predetermined period, a blinking determining unit configured to determine whether the target traffic signal included in the traffic signal area is blinking, and a lamp color determining unit configured to determine a lamp color state indicating a turn-off color or a turn-on color of the target traffic signal included in the traffic signal area detected by the traffic signal detecting unit at intervals of the predetermined period, wherein the blinking determining unit determines whether the target traffic signal is blinking on the basis of a turn-off maintenance time which is a time in which turning-off of the target traffic signal is maintained and a turn-on maintenance time which is a time in which turning-on of the target traffic signal is maintained and outputs blinking information indicating a blinking state or a non-blinking state and determines whether the target traffic signal is blinking on the basis of a pre-turn-off lamp color which is a lamp color immediately before the target traffic signal is turned off when the target traffic signal changes from a turn-on state to a turn-off state and a current turn-on color determined by the lamp color determining unit; and a notification unit configured to notify an occupant of the host vehicle that the host vehicle is to stop when the lamp color determining unit determines that the turn-on color of the target traffic signal is a turn-on color indicating caution, the blinking determining unit outputs blinking information indicating a blinking state, another traffic participant is detected at a crossing correlated with the target traffic signal from the front-view image captured by the imaging unit, and the host vehicle is going to enter the crossing.

(10) According to another aspect of the present invention, there is provided a vehicle control device including: a traffic signal recognition device including an imaging unit configured to capture a front-view image from a host vehicle, a traffic signal detecting unit configured to detect a traffic signal area including a target traffic signal from the front-view image captured by the imaging unit at intervals of a predetermined period, a blinking determining unit configured to determine whether the target traffic signal included in the traffic signal area is blinking, and a lamp color determining unit configured to determine a lamp color state indicating a turn-off color or a turn-on color of the target traffic signal included in the traffic signal area detected by the traffic signal detecting unit at intervals of the predetermined period, wherein the blinking determining unit determines whether the target traffic signal is blinking on the basis of a turn-off maintenance time which is a time in which turning-off of the target traffic signal is maintained and a turn-on maintenance time which is a time in which turning-on of the target traffic signal is maintained and outputs blinking information indicating a blinking state or a non-blinking state and determines whether the target traffic signal is blinking on the basis of a pre-turn-off lamp color which is a lamp color immediately before the target traffic signal is turned off when the target traffic signal changes from a turn-on state to a turn-off state and a current turn-on color determined by the lamp color determining unit; and a notification unit configured to notify an occupant of the host vehicle that the host vehicle is to stop when the lamp color determining unit determines that the lamp color of the target traffic signal is a turn-on color indicating stop, the blinking determining unit outputs blinking information indicating a blinking state, and the host vehicle is going to enter a crossing.

(11) According to another aspect of the present invention, there is provided a vehicle control device including a traffic signal recognition device including an imaging unit configured to capture a front-view image from a host vehicle, a traffic signal detecting unit configured to detect a traffic signal area including a target traffic signal from the front-view image captured by the imaging unit at intervals of a predetermined period, a blinking determining unit configured to determine whether the target traffic signal included in the traffic signal area is blinking, and a lamp color determining unit configured to determine a lamp color state indicating a turn-off color or a turn-on color of the target traffic signal included in the traffic signal area detected by the traffic signal detecting unit at intervals of the predetermined period, wherein the blinking determining unit determines whether the target traffic signal is blinking on the basis of a turn-off maintenance time which is a time in which turning-off of the target traffic signal is maintained and a turn-on maintenance time which is a time in which turning-on of the target traffic signal is maintained and outputs blinking information indicating a blinking state or a non-blinking state and determines whether the target traffic signal is blinking on the basis of a pre-turn-off lamp color which is a lamp color immediately before the target traffic signal is turned off when the target traffic signal changes from a turn-on state to a turn-off state and a current turn-on color determined by the lamp color determining unit, and wherein the host vehicle is controlled such that the host vehicle stops temporarily at a stop line of a crossing when the lamp color determining unit determines that the turn-on color of the target traffic signal is a turn-on color indicating stop, the blinking determining unit outputs blinking information indicating a blinking state, and the host vehicle is going to enter the crossing and the host vehicle enters the crossing when another traffic participant is not detected at the crossing correlated with the target traffic signal from the front-view image captured by the imaging unit.

(12) According to another aspect of the present invention, there is provided a traffic signal recognition method that is performed by a computer, the traffic signal recognition method including: detecting a traffic signal area including a target traffic signal from a front-view image captured by an imaging unit configured to capture a front-view image from a host vehicle at intervals of a predetermined period; determining whether the target traffic signal included in the traffic signal area is blinking; determining whether the target traffic signal is blinking on the basis of a turn-off maintenance time which is a time in which turning-off of the target traffic signal is maintained and a turn-on maintenance time which is a time in which turning-on of the target traffic signal is maintained; and outputting blinking information indicating a blinking state or a non-blinking state.

(13) According to another aspect of the present invention, there is provided a non-transitory computer-readable storage medium storing a program, the program causing a computer to perform: detecting a traffic signal area including a target traffic signal from a front-view image captured by an imaging unit configured to capture a front-view image from a host vehicle at intervals of a predetermined period; determining whether the target traffic signal included in the traffic signal area is blinking; determining whether the target traffic signal is blinking on the basis of a turn-off maintenance time which is a time in which turning-off of the target traffic signal is maintained and a turn-on maintenance time which is a time in which turning-on of the target traffic signal is maintained; and outputting blinking information indicating a blinking state or a non-blinking state.

According to the aspects of (1), (2), (3), (12), and (13), it is possible to accurately recognize blinking of a traffic signal.

According to the aspect of (4), it is possible to determine a scene in which a target traffic signal which is blinking is changed to another color.

According to the aspect of (5), it is possible to determine a scene in which a target traffic signal which is blinking stops the blinking.

According to the aspect of (6), it is possible to determine a scene in which a target traffic signal is turned off after the target traffic signal has blinked.

According to the aspect of (7), it is possible to accurately determine blinking in a subsequent period by initializing the turn-off maintenance time and the turn-on maintenance time.

According to the aspect of (8), it is possible to accurately output a lamp color of a target traffic signal according to a blinking state or a non-blinking state.

According to the aspect of (9), it is possible to notify that the host vehicle is to stop when the host vehicle is going to enter a crossing at which a target traffic signal is blinking in a lamp color indicating caution.

According to the aspect of (10), it is possible to notify that the host vehicle is to stop when the host vehicle is going to enter a crossing at which a target traffic signal is blinking in a lamp color indicating stop.

According to the aspect of (11), it is possible to cause the host vehicle to stop autonomously at a crossing with red blinking and to cause the host vehicle to check surroundings at the crossing and to pass through the crossing in a scene in which there is no other traffic participant at the crossing.

### BRIEF DESCRIPTION OF THE DRAWINGS

FIG. 1 is a diagram illustrating a configuration of a vehicle system 1 using a vehicle control device according to an embodiment.

FIG. 2 is a block diagram illustrating an example of functional configurations of a first control unit 110 and a second control unit 120 according to the embodiment.

FIG. 3 is a block diagram illustrating an example of an internal configuration of a recognition unit 112 according to the embodiment.

FIG. 4 is a diagram illustrating an example of functional configurations of a traffic signal detecting unit 300 and a blinking determining unit 304 according to the embodiment.

FIG. 5 is a diagram schematically illustrating a process that is performed by the blinking determining unit 304 according to the embodiment.

FIG. 6 is a diagram illustrating an example of a functional configuration of the blinking determining unit 304 according to the embodiment.

FIG. 7 is a flowchart illustrating an example of a process flow that is performed by a blinking determining module 500 according to the embodiment.

FIG. 8 is a flowchart illustrating an example of a process flow that is performed by a color comparing module 502 according to the embodiment.

FIG. 9 is a flowchart illustrating an example of a process flow that is performed by a turn-off maintenance time determining module 504 according to the embodiment.

FIG. 10 is a flowchart illustrating an example of a process flow that is performed by a turn-on maintenance time determining module 506 according to the embodiment.

FIG. 11 is a flowchart illustrating an example of a process flow that is performed by an output managing module 508 according to the embodiment.

### DETAILED DESCRIPTION OF THE INVENTION

Hereinafter, a traffic signal recognition device, a traffic signal recognition method, a vehicle control device, and a storage medium according to an embodiment of the present invention will be described with reference to the accompanying drawings.

### (Entire Configuration)

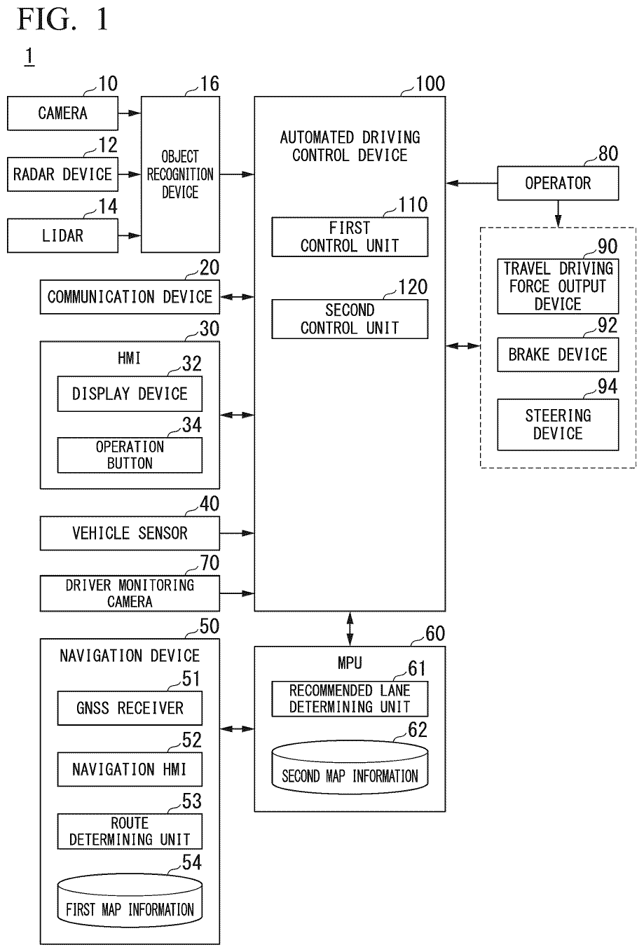

FIG. 1 is a diagram illustrating a configuration of a vehicle system 1 employing a vehicle control device according to an embodiment. A vehicle in which the vehicle system 1 is mounted is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell.

The vehicle system 1 includes, for example, a camera 10, a radar device 12, a Light Detection and Ranging (LIDAR) device 14, an object recognition device 16, a communication device 20, a human-machine interface (HMI) 30, a vehicle sensor 40, a navigation device 50, a map positioning unit (MPU) 60, a driver monitoring camera 70, an operator 80, an automated driving control device 100, a travel driving force output device 90, a brake device 92, and a steering device 94. These devices or instruments are connected to each other via a multiplex communication line such as a controller area network (CAN) communication line, a serial communication line, a radio communication network, or the like. The configuration illustrated in FIG. 1 is only an example, and a part of the configuration may be omitted or another configuration may be added thereto.

The camera 10 is an imaging unit that captures a front-view image from the host vehicle M. The camera 10 is, for example, a digital camera using a solid-state imaging device such as a charge coupled device (CCD) or a complementary metal oxide semiconductor (CMOS). The camera 10 is attached to an arbitrary position on a vehicle (hereinafter referred to as a host vehicle M) in which the vehicle system 1 is mounted. When a front view is imaged, the camera 10 is attached to an upper part of a front windshield, a rear surface of a rearview mirror, or the like. An imaging direction of the camera 10 is preferably set to a range in which a traffic signal can be imaged. The camera 10 images the surroundings of the host vehicle M, for example, periodically and repeatedly. The camera 10 may be a stereo camera.

The radar device 12 radiates radio waves such as millimeter waves to the surroundings of the host vehicle M, detects radio waves (reflected waves) reflected by an object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The LIDAR device 14 radiates light (or electromagnetic waves of wavelengths close to light) to the surroundings of the host vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the host vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the automated driving control device 100. The object recognition device 16 may output the results of detection from the camera 10, the radar device 12, and the LIDAR device 14 to the automated driving control device 100 without any change. The object recognition device 16 may be omitted from the vehicle system 1.

The communication device 20 communicates with other vehicles near the host vehicle M, for example, using a cellular network, a Wi-Fi network, Bluetooth (registered trademark), or dedicated short range communication (DSRC) or communicates with various server devices via radio base stations.

The HMI 30 presents various types of information to an occupant of the host vehicle M and receives an input operation from the occupant. The HMI 30 includes, for example, a display device 32 and an operation button 34 and may include a speaker or a buzzer.

The vehicle sensor 40 includes a vehicle speed sensor that detects a speed of the host vehicle M, an acceleration sensor that detects acceleration, a yaw rate sensor that detects an angular velocity around a vertical axis, and a direction sensor that detects a direction of the host vehicle M.

The navigation device 50 includes, for example, a global navigation satellite system (GNSS) receiver 51, a navigation HMI 52, and a route determining unit 53.

The navigation device 50 stores first map information 54 in a storage device such as a hard disk drive (HDD) or a flash memory.

The GNSS receiver 51 identifies a position of the host vehicle M on the basis of signals received from GNSS satellites. The position of the host vehicle M may be identified or complemented by an inertial navigation system (INS) using the output of the vehicle sensor 40.

The navigation HMI 52 includes a display device, a speaker, a touch panel, and keys. The navigation HMI 52 may be partially or wholly shared by the HMI 30.

For example, the route determining unit 53 determines a route (hereinafter referred to as a route on a map) from the position of the host vehicle M identified by the GNSS receiver 51 (or an input arbitrary position) to a destination input by an occupant using the navigation HMI 52 with reference to the first map information 54.

The first map information 54 is, for example, information in which a road shape is expressed by links indicating a road and nodes connected by the links. The first map information 54 may include a curvature of a road and point of interest (POI) information. The route on a map is output to the MPU 60. The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determining unit 61 and stores second map information 62 in a storage device such as an HDD or a flash memory. The recommended lane determining unit 61 divides the route on a map provided from the navigation device 50 into a plurality of blocks (for example, blocks every 100 [m] in a vehicle traveling direction) and determines a recommended lane for each block with reference to the second map information 62. The recommended lane determining unit 61 determines in which lane from the leftmost the host vehicle Mis to travel. When there is a branching point in the route on a map, the recommended lane determining unit 61 determines the recommended lane such that the host vehicle M can travel along a rational route for traveling to the branching destination.

The second map information 62 is map information with higher precision than the first map information 54. For example, the second map information 62 may include information of centers of lanes and information of boundaries of lanes. The second map information 62 may include road information, traffic regulation information, address information (addresses and postal codes), facility information, phone number information, and information of a prohibited section in which mode A or mode B which will be described later is prohibited. The second map information 62 may include information correlated with a traffic signal and a crossing. The second map information 62 may be updated from time to time by causing the communication device 20 to communicate with another device.

The driver monitoring camera 70 is, for example, a digital camera using a solid-state imaging device such as a CCD or a CMOS. The driver monitoring camera 70 is attached to an arbitrary position on the host vehicle M in a place and a direction in which the head of an occupant (hereinafter referred to as a driver) sitting on a driver's seat of the host vehicle M can be imaged from the front (such that the face of the driver is imaged). For example, the driver monitoring camera 70 is attached to an upper part of a display device which is provided at the center of an instrument panel of the host vehicle M.

The operator 80 includes, for example, a steering wheel, an accelerator pedal, a brake pedal, a shift lever, and other operators. A sensor that detects an amount of operation or whether an operation has been performed is attached to the operator 80, and results of detection of the sensor are output to the automated driving control device 100 or output to some or all of the travel driving force output device 90, the brake device 92, and the steering device 94. The operator 80 may not have to have a ring shape and may have a shape such as a deformed steering wheel, a joystick, or a button.

The automated driving control device 100 includes a first control unit 110 and a second control unit 120. The first control unit 110 and the second control unit 120 are realized, for example, by causing a hardware processor such as a central processing unit (CPU) to execute a program (software). Some or all of these constituents may be realized by hardware (a circuit part including circuitry) such as a large scale integration (LSI) device, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the automated driving control device 100 in advance, or may be stored in a removable storage medium such as a DVD or a CD-ROM and installed in the HDD or the flash memory of the automated driving control device 100 by setting the removable storage medium (a non-transitory storage medium) into a drive device.

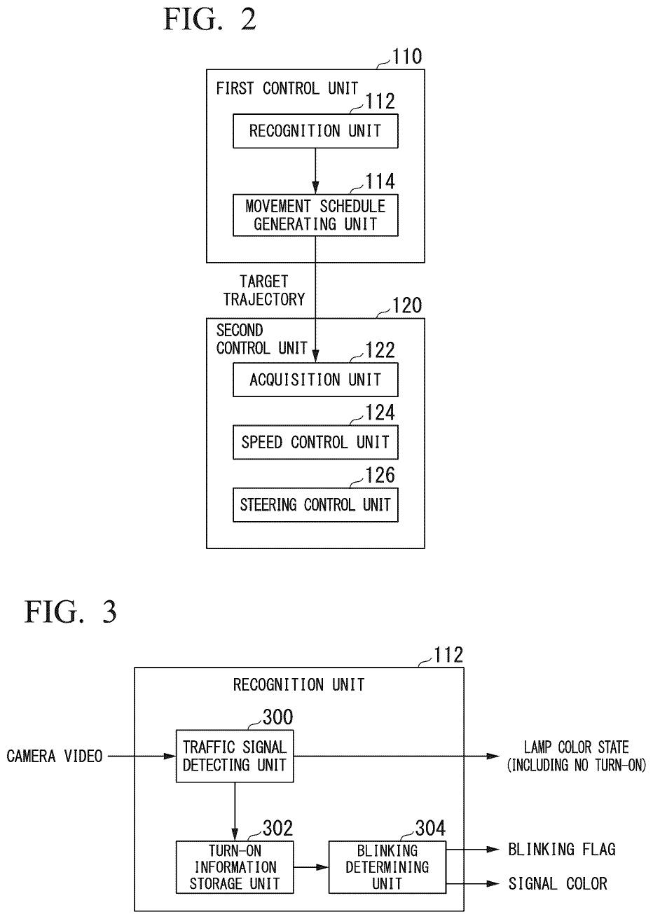

FIG. 2 is a block diagram illustrating an example of functional configurations of the first control unit 110 and the second control unit 120 according to the embodiment. The first control unit 110 includes, for example, a recognition unit 112 and a movement schedule generating unit 114. The first control unit 110 may be realized, for example, by both a function based on artificial intelligence (AI) and a function based on a predetermined model.

The recognition unit 112 recognizes a signal state of a traffic signal, a signal color, and a blinking flag on the basis of information input via the camera 10. The signal state of a traffic signal is information indicating that the traffic signal is not turned on or is turned on. The signal color is, for example, one of red, yellow, and green. The blinking flag indicates one of a blinking state (on) and a non-blinking state (off).

The recognition unit 112 may recognize a position of an object or the like near the host vehicle M. The recognition unit 112 may recognize a position of an object or the like on the basis of information input from the radar device 12 and the LIDAR device 14 via the object recognition device 16. A position of an object is recognized, for example, as a position in an absolute coordinate system with a representative point (such as the center of gravity or a drive shaft center) of the host vehicle M as an origin and is used for control. A position of an object may be expressed as a representative point such as the center of gravity or a corner of the object or may be expressed as an area.

The recognition unit 112 may recognize, for example, a lane (a traveling lane) in which the host vehicle M is traveling (a traveling lane recognizing unit). For example, the recognition unit 112 recognizes the traveling lane by comparing a pattern of road marking lines acquired from the second map information 62 (which may hereinafter be referred to as a “map road marking line) with a pattern of road marking lines near the host vehicle M recognized from an image captured by the camera 10 (which may hereinafter be referred to as a “camera road marking line”) in a monitoring range (a comparison range). The monitoring range may be a detection limit range of the recognition unit 112 or may be a part of the detection limit range. When another vehicle is traveling in the monitoring range in front of the host vehicle M, the recognition unit 112 may determine the camera road marking line to be compared with the map road marking line with reference to a trajectory of the other vehicle. For example, the recognition unit 112 may determine a marking line in a direction along the trajectory (speed) of the other vehicle out of a plurality of marking lines which are candidates for the camera road marking line as a camera road marking line.

The recognition unit 112 may recognize a position or a posture of the host vehicle M relative to the traveling lane at the time of recognition of the traveling lane. The recognition unit 112 may recognize, for example, a degree of separation of a reference point of the host vehicle M from the lane center and an angle of the traveling direction of the host vehicle M with respect to a line formed by connecting the lane centers as the relative position and the relative posture of the host vehicle M with respect to the traveling lane. Instead, the recognition unit 112 may recognize a position of a reference point of the host vehicle M with respect to one side line of the traveling lane (a road marking line or a road boundary) or the like as the relative position of the host vehicle M with respect to the traveling lane.

The movement schedule generating unit 114 generates a target trajectory in which the host vehicle M will travel autonomously (without requiring a driver's operation) in the future such that the host vehicle M travels in a recommended lane determined by the recommended lane determining unit 61 in principle and avoids approach of the host vehicle M to an object (other than an object which the host vehicle M can go over such as a road marking line, a road marking, or a manhole) recognized by the recognition unit 112. For example, the target trajectory is expressed by sequentially arranging points (trajectory points) at which the host vehicle M is to arrive. Trajectory points are points at which the host vehicle Mis to arrive at intervals of a predetermined traveling distance (for example, about several [m]) along a road, and a target speed and a target acceleration at intervals of a predetermined sampling time (for example, below the decimal point [sec]) are generated as a part of the target trajectory in addition thereto.

The movement schedule generating unit 114 may set events of automated driving in generating a target trajectory. The events of automated driving include a constant-speed travel event, a low-speed following travel event, a lane change event, a branching event, a merging event, and an overtaking event. The movement schedule generating unit 114 generates a target trajectory based on an event which is started.

The second control unit 120 includes, for example, an acquisition unit 122, a speed control unit 124, and a steering control unit 126. The acquisition unit 122 acquires information of the target trajectory (trajectory points) generated by the movement schedule generating unit 114 and stores the acquired information in a memory (not illustrated). The speed control unit 124 controls the travel driving force output device 90 or the brake device 92 on the basis of speed elements accessory to the target trajectory stored in the memory. The steering control unit 126 controls the steering device 94 on the basis of a curved state of the target trajectory stored in the memory. The processes of the speed control unit 124 and the steering control unit 126 are realized, for example, by feed-forward control and feedback control in combination. For example, the steering control unit 126 performs control in combination of feed-forward control based on a curvature of a road in front of the host vehicle M and feedback control based on separation from the target trajectory.

The travel driving force output device 90 outputs a travel driving force (a torque) for allowing the vehicle to travel to driving wheels. The travel driving force output device 90 includes, for example, a combination of an internal combustion engine, an electric motor, and a transmission and an electronic control unit (ECU) that controls them. The ECU controls these constituents on the basis of information input from the second control unit 120 or information input from the operator 80.

The brake device 92 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second control unit 120 or the information input from the operator 80 such that a brake torque based on a braking operation is output to vehicle wheels. The brake device 92 may include a mechanism for transmitting a hydraulic pressure generated by an operation of the brake pedal included in the operator 80 to the cylinder via a master cylinder as a backup. The brake device 92 is not limited to the above-mentioned configuration and may be an electronically controlled hydraulic brake device that controls an actuator on the basis of information input from the second control unit 120 such that the hydraulic pressure of the master cylinder is transmitted to the cylinder.

The steering device 94 includes, for example, a steering ECU and an electric motor. The electric motor changes a direction of turning wheels, for example, by applying a force to a rack-and-pinion mechanism. The steering ECU drives the electric motor on the basis of the information input from the second control unit 120 or the information input from the operator 80 to change the direction of the turning wheels.

### (Entire Functional Configuration and Process of Recognition Unit 112)

FIG. 3 is a block diagram illustrating an example of an internal configuration of the recognition unit 112 according to the embodiment. The recognition unit 112 includes, for example, a traffic signal detecting unit 300, a turn-on information storage unit 302, and a blinking determining unit 304.

The traffic signal detecting unit 300 is supplied with a video from the camera 10. The traffic signal detecting unit 300 detects a traffic signal area including a target traffic signal from a front-view image captured by the camera 10 at intervals of a predetermined period.

The turn-on information storage unit 302 stores a pre-turn-off lamp color which is a process result from the traffic signal detecting unit 300. The pre-turn-off lamp color is a lamp color immediately before the target traffic signal is turned off when the target traffic signal has changed from a turn-on state to a turn-off state. The turn-on information storage unit 302 stores a blinking flag, a turn-off maintenance time, and a turn-on maintenance time as internal parameters.

The blinking determining unit 304 determines whether the target traffic signal included in the traffic signal area is blinking. The blinking determining unit 304 determines whether the target traffic signal is blinking on the basis of the turn-off maintenance time and the turn-on maintenance time and outputs blinking information. The turn-off maintenance time is a time in which turn-off of the target traffic signal is maintained. The turn-on maintenance time is a time in which turn-on of the target traffic signal is maintained. The blinking information is a blinking flag indicating a blinking state or a non-blinking state.

In the embodiment, it is assumed that the recognition unit 112 detects and tracks both a traffic signal corresponding to a traveling lane in which the host vehicle Mis traveling and a traffic signal at a crossing which the host vehicle Mis to enter. It is assumed that the blinking period of the traffic signal is set to a value corresponding to a region or a country. The recognition unit 112 detects three colors of red, yellow, and green as a lamp color of a traffic signal, but the present invention is not limited thereto, and it is assumed that the recognition unit 112 may recognize a traffic signal of one color or two colors.

The recognition unit 112 in the present embodiment can recognize following scenes (1), (2), and (3).

(1) A scene in which a target traffic signal changes from a blinking state to a different lamp color

(2) A scene in which a target traffic signal changes from a blinking state to a non-blinking state

(3) A scene in which a target traffic signal is not turned on after the target traffic signal has blinked

In the scene (1), for example, the target traffic signal changes from red blinking to yellow. In the scene (2), for example, the target traffic signal changes from red blinking to red. In the scene (3), for example, the target traffic signal changes from red blinking to a turn-off state.

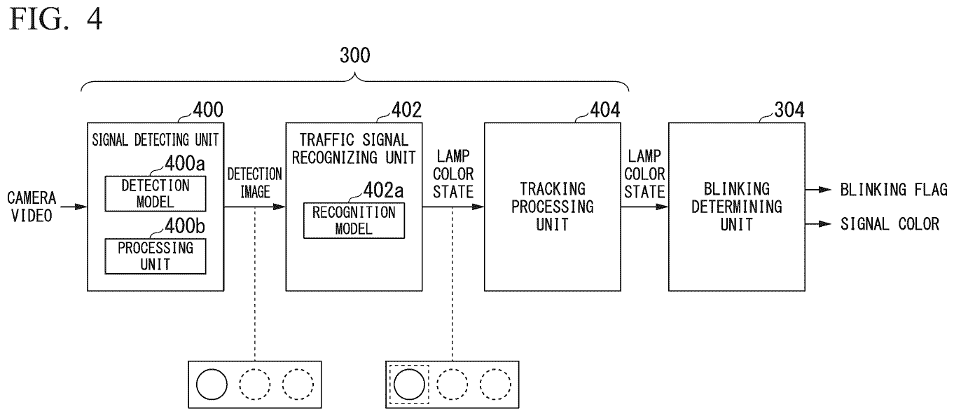

FIG. 4 is a diagram illustrating an example of functional configurations of the traffic signal detecting unit 300 and the blinking determining unit 304 according to the embodiment.

The traffic signal detecting unit 300 includes, for example, a signal detecting unit 400, a traffic signal recognizing unit 402 (a lamp color determining unit), and a tracking processing unit 404.

The signal detecting unit 400 receives an input of a video output from the camera 10, detects a traffic signal using a detection model 400a, and extracts an area including the traffic signal using a processing unit 400b. The detection model 400a is, for example, a deep neural network (DNN) having learned an image including a traffic signal as training data. The image from which the area including the traffic signal has been detected is output to the traffic signal recognizing unit 402.

The traffic signal recognizing unit 402 recognizes an area in which a signal is turned on or blinking in the detection image and recognizes a turn-on color. The traffic signal recognizing unit 402 serves as a lamp color determining unit that determines a lamp color state indicating a turn-off color or a turn-on color of a target traffic signal included in the detected traffic signal area at intervals of a predetermined period. For example, the traffic signal recognizing unit 402 uses a recognition model 402a having learned the image from which the traffic signal has been extracted as training data. The traffic signal recognizing unit 402 inputs the detection image to the recognition model 402a and acquires a prediction result and a lamp color state of the area in which a traffic signal is blinking or turned on output from the recognition model 402a.

The tracking processing unit 404 receives an input of the prediction result and the lamp color state of the area in which a traffic signal is blinking or turned on from the traffic signal recognizing unit 402 and tracks the area in which a traffic signal is blinking or turned on. The tracking processing unit 404 outputs the lamp color state as a tracking result to the blinking determining unit 304.

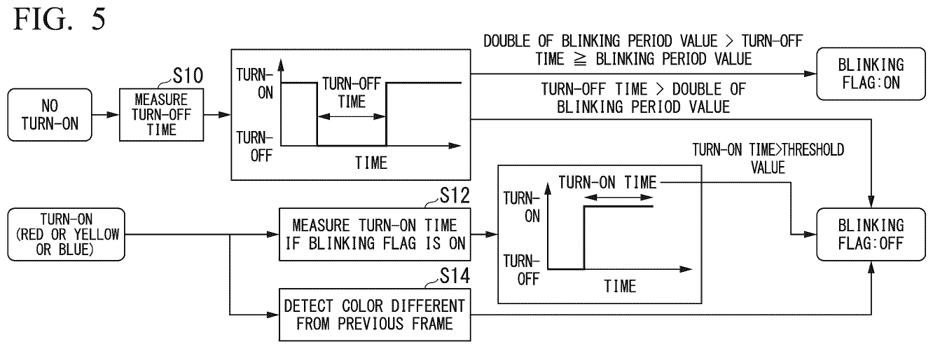

FIG. 5 is a diagram schematically illustrating a process that is performed by the blinking determining unit 304 according to the embodiment.

When a lamp color state indicating that a target traffic signal is not turned on is acquired, the blinking determining unit 304 measures a turn-off maintenance time (Step S10). The turn-off maintenance time is a period from a time at which turn-on has stopped to a time at which turn-on starts again.

The blinking determining unit 304 sets the blinking flag to ON when the measured turn-off maintenance time satisfies a relationship 2×blinking period value>turn-off maintenance time≥blinking period value. The blinking period value is a preset value and is a threshold value for determining blinking of a traffic signal.

The blinking determining unit 304 sets the blinking flag to OFF when the measured turn-off maintenance time satisfies a relationship turn-off maintenance time>2×blinking period value.

The blinking determining unit 304 measures a turn-on maintenance time when the target traffic signal is turned on and the blinking flag is ON (Step S12). The turn-on maintenance time is a continuous period from a time at which the target traffic signal has changed from a turn-off state to a turn-on state. When the turn-on maintenance time is greater than a threshold value, the blinking determining unit 304 sets the blinking flag to OFF. When the threshold value for the turn-on maintenance time is set to a value for determining that it is longer than the turn-on maintenance time when the target traffic signal is blinking. The threshold value for the turn-on maintenance time is set to, for example, a time corresponding to 1.5 times the blinking period.

When the target traffic signal is turned on and a turn-on color different from that in the previous frame is detected (Step S14), the blinking determining unit 304 sets the blinking flag to OFF.

A lamp color state indicting only whether the target traffic signal is turned on may be input to the blinking determining unit 304. In this case, the blinking determining unit 304 may not perform the process of Step S14. The blinking determining unit 304 can determine whether the target traffic signal is blinking on the basis of the turn-off maintenance time which is a time in which the target traffic signal is maintained in the turn-off state and the turn-on maintenance time which is a time in which the target traffic signal is maintained in the turn-on state and output blinking information indicating a blinking state or a non-blinking state.

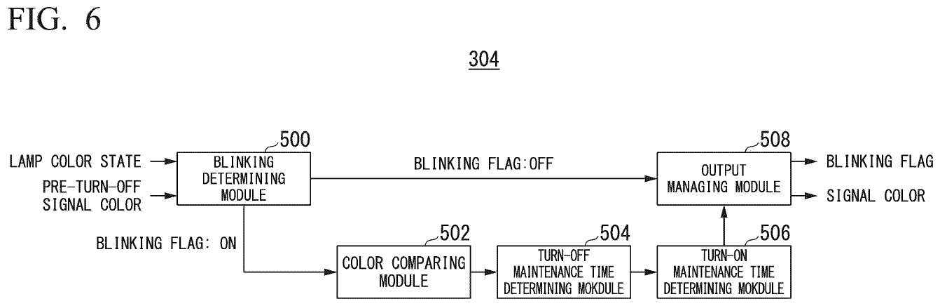

FIG. 6 is a diagram illustrating an example of a functional configuration of the blinking determining unit 304 according to the embodiment. The blinking determining unit 304 includes, for example, a blinking determining module 500, a color comparing module 502, a turn-off maintenance time determining module 504, a turn-on maintenance time determining module 506, and an output managing module 508. Each of the blinking determining module 500, the color comparing module 502, the turn-off maintenance time determining module 504, and the turn-on maintenance time determining module 506 is a functional unit which is realized by causing a computer such as a CPU to execute a program.

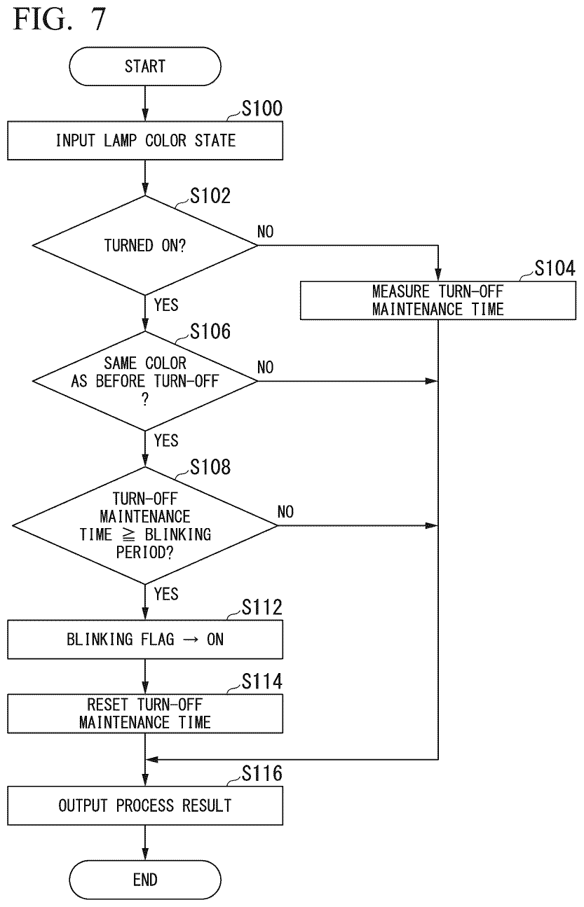

FIG. 7 is a flowchart illustrating an example of a process flow that is performed by the blinking determining module 500 according to the embodiment.

The blinking determining module 500 receives an input of a lamp color state from the traffic signal detecting unit 300 (Step S100) and determines whether the target traffic signal is turned on on the basis of a traffic signal state (Step S102). When the target traffic signal is currently in the turn-off state (Step S102: NO), the blinking determining module 500 measures the turn-off maintenance time by adding a predetermined amount of elapsed time to the turn-off maintenance time (Step S104) and outputs the turn-off maintenance time as a process result (Step S116).

When the target traffic signal is currently in the turn-on state (Step S102: YES), the blinking determining module 500 determines whether the current turn-on color is the same as a pre-turn-off lamp color (Step S108). When the current turn-on color is not the same as the pre-turn-off lamp color (Step S108: NO), the blinking determining module 500 does not change and outputs the blinking flag (Step S116).

When the current turn-on color is the same as the pre-turn-off lamp color (Step S108: YES), the blinking determining module 500 determines whether the turn-off maintenance time is equal to or greater than a blinking period (Step S110). When the turn-off maintenance time is not equal to or greater than the blinking period (Step S110: NO), the blinking determining module 500 does not change and outputs the blinking flag (Step S116). When the turn-off maintenance time is equal to or greater than the blinking period (Step S110: YES), the blinking determining module 500 sets the blinking flag to ON (Step S112), resets the turn-off maintenance time (Step S114), and outputs the blinking flag (Step S116).

In this way, the blinking determining unit 304 can add a predetermined amount of elapsed time to the turn-off maintenance time when the current lamp color state is the turn-off state and change the blinking information (the blinking flag) from the non-blinking state (OFF) to the blinking state (ON) when the current lamp color state is not the turn-off state and indicates the same turn-on color as the pre-turn-off lamp color and the turn-off maintenance time is greater than the first time threshold value (a blinking period) corresponding to a predetermined blinking period. Accordingly, it is possible to accurately determine whether the target traffic signal is blinking.

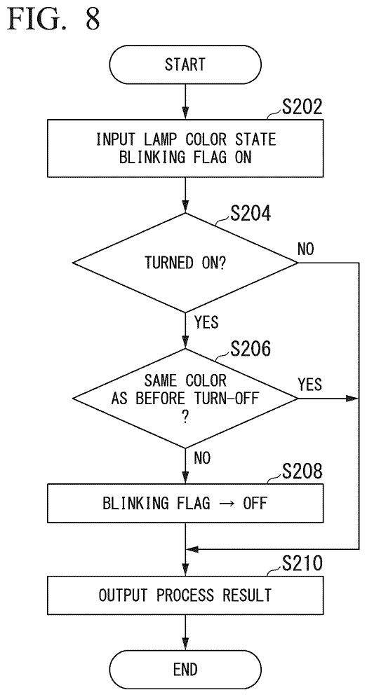

FIG. 8 is a flowchart illustrating an example of a process flow that is performed by the color comparing module 502 according to the embodiment.

The color comparing module 502 starts when the blinking flag is ON and receives an input of a lamp color state (Step S202). The color comparing module 502 determines whether the target traffic signal is turned on on the basis of the lamp color state output from the traffic signal detecting unit 300 (Step S204). When the current lamp color state is the turn-off state (Step S204: NO), the color comparing module 502 does not change and outputs the blinking flag (Step S210).

When the current lamp color state is the turn-on state (Step S204: YES), the color comparing module 502 determines whether the current turn-on color is the same as the pre-turn-off lamp color (Step S206). When the current turn-on color is not the same as the pre-turn-off lamp color (Step S206: NO), the color comparing module 502 sets the blinking flag to OFF (Step S208) and outputs the blinking flag (Step S210).

When the current turn-on color is the same as the pre-turn-off lamp color (Step S206: YES), the color comparing module 502 does not change and outputs the blinking flag (Step S210).

In this way, when the blinking information indicates the blinking state, the current turn-on color does not indicate the turn-off state and is not the same turn-on color as the pre-turn-off lamp color, the blinking determining unit 304 can change the blinking information from the blinking state to the non-blinking state. Accordingly, the blinking determining unit 304 can determine a scene in which the target traffic signal changes from the blinking state to a different color. For example, it is possible to determine that the target traffic signal changes from red blinking to yellow.

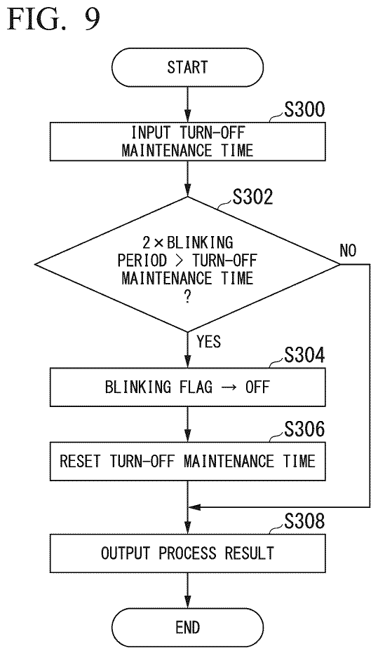

FIG. 9 is a flowchart illustrating an example of a process flow that is performed by the turn-off maintenance time determining module 504 according to the embodiment.

The turn-off maintenance time determining module 504 starts when the blinking flag is ON, receives an input of a turn-off maintenance time (Step S300), and determines whether the turn-off maintenance time is less than double (the second time threshold value) the blinking period (the first time threshold value) (Step S302). When the turn-off maintenance time is not less than double the blinking period (Step S302: NO), the turn-off maintenance time determining module 504 outputs the determination result (Step S308).

When the turn-off maintenance time is less than double the blinking period (Step S302: YES), the turn-off maintenance time determining module 504 sets the blinking flag to OFF (Step S304), resets the turn-off maintenance time (Step S306), and outputs the blinking flag as a process result (Step S308).

In this way, when the blinking information indicates the blinking state and the turn-off maintenance time is less than the second time threshold value greater than the first time threshold value, the blinking determining unit 304 can change the blinking information from the blinking state to the non-blinking state. Accordingly, the blinking determining unit 304 can determine a scene in which the target traffic signal changes from the blinking state to the non-blinking state. For example, it is possible to determine a scene in which the target traffic signal changes from red blinking to red.

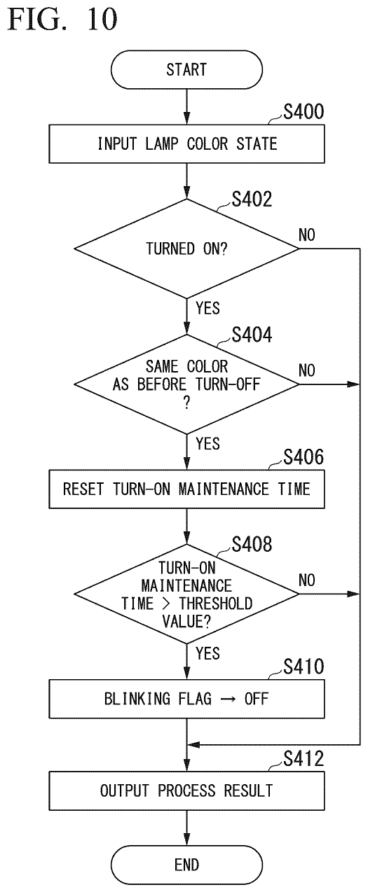

FIG. 10 is a flowchart illustrating an example of a process flow that is performed by the turn-on maintenance time determining module 506 according to the embodiment.

The turn-on maintenance time determining module 506 starts when the blinking flag is ON, receives an input of a traffic signal state from the traffic signal detecting unit 300 (Step S400), and determines whether the target traffic signal is turned on on the basis of the lamp color state (Step S402). When the target traffic signal is currently in the turn-off state (Step S402: NO), the turn-on maintenance time determining module 506 outputs a process result indicating that the turn-on maintenance time is 0 (Step S412).

When the current lamp color state is the turn-on state (Step S402: YES), the turn-on maintenance time determining module 506 determines whether the current turn-on color is the same as the pre-turn-off lamp color (Step S404). When the current turn-on color is not the same as the pre-turn-off lamp color (Step S404: NO), the turn-on maintenance time determining module 506 outputs a process result indicating that the turn-on maintenance time is 0 (Step S412).

When the current turn-on color is the same as the pre-turn-off lamp color (Step S404: YES), the turn-on maintenance time determining module 506 measures the turn-on maintenance time (Step S406) and determines whether the turn-on maintenance time is greater than a threshold value (1.5 times the blinking period) (Step S408). When the turn-on maintenance time is greater than the threshold value (1.5 times the blinking period) (Step S408: YES), the turn-on maintenance time determining module 506 sets the blinking flag to OFF (Step S410) and outputs the blinking flag (Step S412).

In this way, the blinking determining unit 304 adds a predetermined amount of elapsed time to the turn-on maintenance time when the blinking information indicates the blinking state and the target traffic signal is not in the turn-off state but indicates the same turn-on color as the pre-turn-off lamp color and changes the blinking information from the blinking state to the non-blinking state when the turn-on maintenance time is greater than the third time threshold value (1.5 times the blinking period) greater than the first time threshold value (the blinking period). Accordingly, the blinking determining unit 304 can determine a scene in which the target traffic signal has changed from the blinking state to the turn-off state.

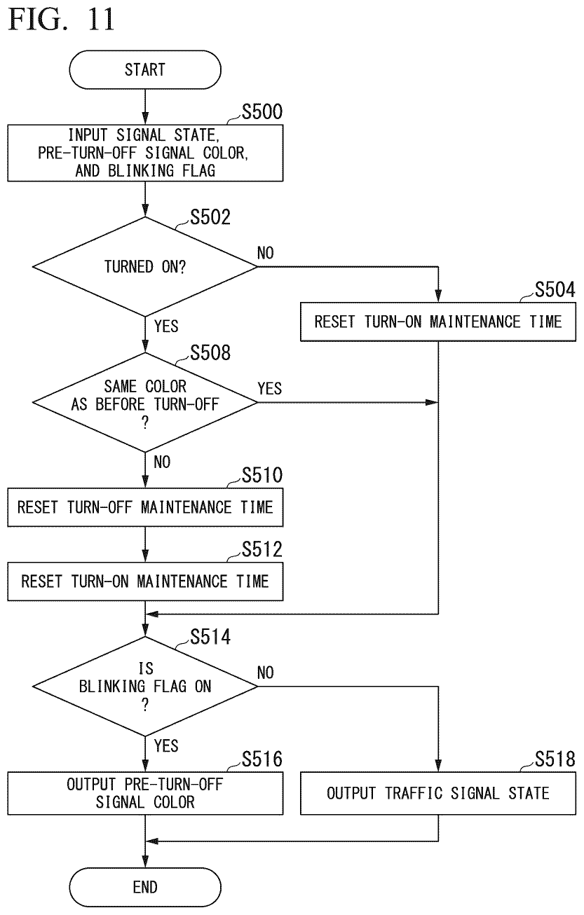

FIG. 11 is a flowchart illustrating an example of a process flow that is performed by the output managing module 508 according to the embodiment.

The output managing module 508 receives an input of the lamp color state, the pre-turn-off lamp color, and the blinking flag from the traffic signal detecting unit 300 (Step S500) and determines whether the target traffic signal is turned on on the basis of the lamp color state (Step S502). When the target traffic signal is currently in the turn-off state (Step S402: NO), the output managing module 508 resets the turn-on maintenance time (Step S504) and causes the process flow to proceed to Step S514.

When the current lamp color state is the turn-on state (Step S502: YES), the output managing module 508 determines whether the current turn-on color is the same as the pre-turn-off lamp color (Step S508). When the current turn-on color is the same as the pre-turn-off lamp color (Step S508: YES), the output managing module 508 causes the process flow to proceed to Step S514.

When the current turn-on color is not the same as the pre-turn-off lamp color (Step S508: NO), the output managing module 508 resets the turn-off maintenance time (Step S510), resets the turn-on maintenance time (Step S512), and determines whether the blinking flag is ON (Step S514).

When the blinking flag is ON (Step S514: YES), the output managing module 508 outputs the pre-turn-off lamp color (Step S516). When the blinking flag is not ON (Step S514: NO), the output managing module 508 outputs a traffic signal state including the blinking flag and the turn-on color (Step S518).

In this way, the blinking determining unit 304 sets the turn-on maintenance time to an initial value (Step S504) when the current turn-on color indicates the turn-off state (Step S502: NO) and sets the turn-off maintenance time and the turn-on maintenance time to the initial value (Steps S510 and S512) when the current turn-on color does not indicate the turn-off state (Step S502: YES) and is a lamp color different from the pre-turn-off lamp color (Step S508: NO). Accordingly, the blinking determining unit 304 can accurately perform blinking determination in a subsequent period.

The blinking determining unit 304 can output the pre-turn-off lamp color as the turn-on color of the traffic signal (Step S516) when the blinking information indicates the blinking state and output the current turn-on color as the turn-on color of the traffic signal (Step S518) when the blinking information indicates the non-blinking state. Accordingly, the blinking determining unit 304 can accurately output the lamp color of the traffic signal according to whether the target traffic signal is in the blinking state or the non-blinking state.

(Vehicle Control Associated with Blinking of Turn-on Color (Yellow Signal) Indicating Caution)

The automated driving control device 100 includes the movement schedule generating unit 114, the speed control unit 124, and the steering control unit 126 and serves as a vehicle control unit that controls the host vehicle M on the basis of a traffic signal state recognized by the recognition unit 112 (the traffic signal recognition device). In the automated driving control device 100, it is assumed that the turn-on color of the target traffic signal is recognized as a turn-on color indicating caution by the recognition unit 112 and blinking information indicating the blinking state is output. At this time, the automated driving control device 100 controls the HMI 30 (a notification unit) such that an occupant of the host vehicle M is notified to stop when another traffic participant is detected as a crossing correlated with the target traffic signal from the front-view image captured by the camera 10 by the object recognition device 16 and the host vehicle M is going to enter the crossing.

Accordingly, when blinking of the turn-on color (a yellow signal) indicating caution is recognized by the recognition unit 112 and the host vehicle M enters the crossing correlated with the target traffic signal blinking in the turn-on color indicating caution, the automated driving control device 100 can notify that the other traffic participant has been detected.

(Vehicle Control (1) Associated with Blinking of Turn-on Color (Red Signal) Indicating Stop)

In the automated driving control device 100, it is assumed that the lamp color of the target traffic signal is recognized as a turn-on color (a red signal) indicating stop by the recognition unit 112 and blinking information indicating the blinking state is output. At this time, when the host vehicle M is going to enter a crossing, the automated driving control device 100 controls the HMI 30 (the notification unit) such that an occupant of the host vehicle M is notified to stop. Accordingly, the automated driving control device 100 can perform notification when blinking of the turn-on color indicating stop is recognized by the recognition unit 112 and the host vehicle M is going to enter the crossing without stopping temporarily.

(Vehicle Control (2) Associated with Blinking of Turn-on Color (Red Signal) Indicating Stop)

In the automated driving control device 100, it is assumed that the turn-on color of the target traffic signal is recognized as a turn-on color indicating stop by the recognition unit 112 and blinking information indicating the blinking state is output. At this time, the automated driving control device 100 can control the host vehicle M such that the host vehicle M stops temporarily in a stop line of the crossing when the host vehicle M is going to enter a crossing and enters the crossing when another traffic participant is not detected at the crossing correlated with the target traffic signal from the front-view image captured by the camera 10. Accordingly, the automated driving control device 100 can enable the host vehicle M to stop temporarily autonomously at the crossing correlated with the target traffic signal when a red signal is blinking and to pass through the crossing when it has been checked that another traffic participant is not detected.

While exemplary embodiments of the present invention have been described above, the present invention is not limited to the embodiments and can have various modifications and substitutions applied thereto without departing from the gist of the present invention.

What is claimed is:

1. A traffic signal recognition device comprising:
an imaging unit configured to capture a front-view image from a host vehicle;
a traffic signal detecting unit configured to detect a traffic signal area including a target traffic signal from the front-view image captured by the imaging unit at intervals of a predetermined period; and
a blinking determining unit configured to determine whether the target traffic signal included in the traffic signal area is blinking,
wherein the blinking determining unit determines whether the target traffic signal is blinking on the basis of a turn-off maintenance time which is a time in which turning-off of the target traffic signal is maintained and a turn-on maintenance time which is a time in which turning-on of the target traffic signal is maintained and outputs blinking information indicating a blinking state or a non-blinking state.

2. The traffic signal recognition device according to claim 1, further comprising a lamp color determining unit configured to determine a lamp color state indicating a turn-off color or a turn-on color of the target traffic signal included in the traffic signal area detected by the traffic signal detecting unit at intervals of the predetermined period,
wherein the blinking determining unit determines whether the target traffic signal is blinking on the basis of a pre-turn-off lamp color which is a lamp color immediately before the target traffic signal is turned off when the target traffic signal changes from a turn-on state to a turn-off state and a current turn-on color determined by the lamp color determining unit.

3. The traffic signal recognition device according to claim 2, wherein the blinking determining unit performs:
adding a predetermined amount of elapsed time to the turn-off maintenance time when a current lamp color state is a turn-off state; and
changing the blinking information from a non-blinking state to a blinking state when the current lamp color state is not a turn-off state but indicates the same turn-on color as the pre-turn-off lamp color, and the turn-off maintenance time is greater than a first time threshold value corresponding to a predetermined blinking period.

4. The traffic signal recognition device according to claim 3, wherein the blinking determining unit changes the blinking information from the blinking state to the non-blinking state when the blinking information indicates the blinking state and the current turn-on color does not indicate the turn-off state but is not the same turn-on color as the pre-turn-off lamp color.

5. The traffic signal recognition device according to claim 3, wherein the blinking determining unit changes the blinking information from the blinking state to the non-blinking state when the blinking information indicates the blinking state and the turn-off maintenance time is less than a second time threshold value greater than the first time threshold value.

6. The traffic signal recognition device according to claim 3, wherein the blinking determining unit performs:
adding a predetermined amount of elapsed time to the turn-on maintenance time when the blinking information indicates the blinking state and the current turn-on color does not indicate the turn-off state but is the same turn-on color as the pre-turn-off lamp color; and
changing the blinking information from the blinking state to the non-blinking state when the turn-on maintenance time is greater than a third time threshold value greater than the first time threshold value.

7. The traffic signal recognition device according to claim 3, wherein the blinking determining unit performs:
setting the turn-on maintenance time to an initial value when the current turn-on color indicates the turn-off state; and
setting the turn-off maintenance time and the turn-on maintenance time to the initial value when the current turn-on color does not indicate the turn-off state but is a lamp color different from the pre-turn-off lamp color.

8. The traffic signal recognition device according to claim 3, wherein the blinking determining unit performs:
outputting the pre-turn-off lamp color as the turn-on color of the target traffic signal when the blinking information indicates the blinking state; and
outputting the current turn-on color as the turn-on color of the target traffic signal when the blinking information indicates the non-blinking state.

9. A vehicle control device comprising:
a traffic signal recognition device including
an imaging unit configured to capture a front-view image from a host vehicle,
a traffic signal detecting unit configured to detect a traffic signal area including a target traffic signal from the front-view image captured by the imaging unit at intervals of a predetermined period,
a blinking determining unit configured to determine whether the target traffic signal included in the traffic signal area is blinking, and
a lamp color determining unit configured to determine a lamp color state indicating a turn-off color or a turn-on color of the target traffic signal included in the traffic signal area detected by the traffic signal detecting unit at intervals of the predetermined period,
wherein the blinking determining unit determines whether the target traffic signal is blinking on the basis of a turn-off maintenance time which is a time in which turning-off of the target traffic signal is maintained and a turn-on maintenance time which is a time in which turning-on of the target traffic signal is maintained and outputs blinking information indicating a blinking state or a non-blinking state and determines whether the target traffic signal is blinking on the basis of a pre-turn-off lamp color which is a lamp color immediately before the target traffic signal is turned off when the target traffic signal changes from a turn-on state to a turn-off state and a current turn-on color determined by the lamp color determining unit; and
a notification unit configured to notify an occupant of the host vehicle that the host vehicle is to stop when the lamp color determining unit determines that the turn-on color of the target traffic signal is a turn-on color indicating caution, the blinking determining unit outputs blinking information indicating a blinking state, another traffic participant is detected at a crossing correlated with the target traffic signal from the front-view image captured by the imaging unit, and the host vehicle is going to enter the crossing.

10. A vehicle control device comprising:
a traffic signal recognition device including
an imaging unit configured to capture a front-view image from a host vehicle,
a traffic signal detecting unit configured to detect a traffic signal area including a target traffic signal from the front-view image captured by the imaging unit at intervals of a predetermined period,
a blinking determining unit configured to determine whether the target traffic signal included in the traffic signal area is blinking, and
a lamp color determining unit configured to determine a lamp color state indicating a turn-off color or a turn-on color of the target traffic signal included in the traffic signal area detected by the traffic signal detecting unit at intervals of the predetermined period,
wherein the blinking determining unit determines whether the target traffic signal is blinking on the basis of a turn-off maintenance time which is a time in which turning-off of the target traffic signal is maintained and a turn-on maintenance time which is a time in which turning-on of the target traffic signal is maintained and outputs blinking information indicating a blinking state or a non-blinking state and determines whether the target traffic signal is blinking on the basis of a pre-turn-off lamp color which is a lamp color immediately before the target traffic signal is turned off when the target traffic signal changes from a turn-on state to a turn-off state and a current turn-on color determined by the lamp color determining unit; and
a notification unit configured to notify an occupant of the host vehicle that the host vehicle is to stop when the lamp color determining unit determines that the lamp color of the target traffic signal is a turn-on color indicating stop, the blinking determining unit outputs blinking information indicating a blinking state, and the host vehicle is going to enter a crossing.

11. A vehicle control device comprising:
a traffic signal recognition device including
an imaging unit configured to capture a front-view image from a host vehicle,
a traffic signal detecting unit configured to detect a traffic signal area including a target traffic signal from the front-view image captured by the imaging unit at intervals of a predetermined period,
a blinking determining unit configured to determine whether the target traffic signal included in the traffic signal area is blinking, and
a lamp color determining unit configured to determine a lamp color state indicating a turn-off color or a turn-on color of the target traffic signal included in the traffic signal area detected by the traffic signal detecting unit at intervals of the predetermined period,
wherein the blinking determining unit determines whether the target traffic signal is blinking on the basis of a turn-off maintenance time which is a time in which turning-off of the target traffic signal is maintained and a turn-on maintenance time which is a time in which turning-on of the target traffic signal is maintained and outputs blinking information indicating a blinking state or a non-blinking state and determines whether the target traffic signal is blinking on the basis of a pre-turn-off lamp color which is a lamp color immediately before the target traffic signal is turned off when the target traffic signal changes from a turn-on state to a turn-off state and a current turn-on color determined by the lamp color determining unit, and
wherein the host vehicle is controlled such that the host vehicle stops temporarily at a stop line of a crossing when the lamp color determining unit determines that the turn-on color of the target traffic signal is a turn-on color indicating stop, the blinking determining unit outputs blinking information indicating a blinking state, and the host vehicle is going to enter the crossing and the host vehicle enters the crossing when another traffic participant is not detected at the crossing correlated with the target traffic signal from the front-view image captured by the imaging unit.

12. A traffic signal recognition method that is performed by a computer, the traffic signal recognition method comprising:
detecting a traffic signal area including a target traffic signal from a front-view image captured by an imaging unit configured to capture a front-view image from a host vehicle at intervals of a predetermined period;
determining whether the target traffic signal included in the traffic signal area is blinking;
determining whether the target traffic signal is blinking on the basis of a turn-off maintenance time which is a time in which turning-off of the target traffic signal is maintained and a turn-on maintenance time which is a time in which turning-on of the target traffic signal is maintained; and
outputting blinking information indicating a blinking state or a non-blinking state.

13. A non-transitory computer-readable storage medium storing a program, the program causing a computer to perform:
detecting a traffic signal area including a target traffic signal from a front-view image captured by an imaging unit configured to capture a front-view image from a host vehicle at intervals of a predetermined period;
determining whether the target traffic signal included in the traffic signal area is blinking;
determining whether the target traffic signal is blinking on the basis of a turn-off maintenance time which is a time in which turning-off of the target traffic signal is maintained and a turn-on maintenance time which is a time in which turning-on of the target traffic signal is maintained; and
outputting blinking information indicating a blinking state or a non-blinking state.
